(19) United States
(12) Patent Application Publication
(10) Pub. No.: US 2018/0018392 A1
(43) Pub. Date: Jan. 18, 2018

(54) TOPIC IDENTIFICATION BASED ON FUNCTIONAL SUMMARIZATION

(71) Applicant: Hewlett-Packard Development Company, L.P ., Fort Collins, CO (US)

(72) Inventor: Steven J Simske, Ft. Collins, CO (US)

(73) Assignee: Hewlett-Packard Development Company, L.P., Fort Collins, CO (US)

(21) Appl. No.: 15/545,791

(22) PCT Filed: Apr. 29, 2015
(86) PCT No.: PCT/US15/28218

§ 371 Date: Jul. 24, 2017

(51) Int. Cl. G06F 17/30

(52) U.S. Cl. CPC G06F 17/30719; G06F 17/30707

(57) ABSTRACT

Topic identification based on functional summarization is disclosed. One example is a system including a plurality of summarization engines, each summarization engine to receive, via a processing system, a document to provide a summary of the document. At least one meta-algorithmic pattern is applied to at least two summaries to provide a meta-summary of the document using the at least two summaries. A content processor identifies, from the meta-summaries, topics associated with the document, maps the identified topics to a collection of topic dimensions, and identifies a representative point based on the identified topics. An evaluator determines distance measures of the representative point from topic dimensions in the collection of topic dimensions, the distance measures indicative of proximity of respective topic dimensions to the representative point. A selector selects a topic dimension to be associated with the document, the selection based on optimizing the distance measures.

### BACKGROUND

Robust systems may be built by utilizing complementary, often largely independent, machine intelligence approaches, such as functional uses of the output of multiple summarizations and meta-algorithmic patterns for combining these summarizers. Summarizers are computer-based applications that provide a summary of some type of content. Meta-algorithmic patterns are computer-based applications that can be applied to combine two or more summarizers, analysis algorithms, systems, or engines to yield meta-summaries. Functional summarization may be used for evaluative purposes and as a decision criterion for analytics, including identification of topics in a document.

### BRIEF DESCRIPTION OF THE DRAWINGS

FIG. 1 is a functional block diagram illustrating one example of a system for topic identification based on functional summarization.

FIG. 2 is a schematic diagram illustrating one example of topics displayed in a topic dimension space.

FIG. 3A is a graph illustrating one example of identifying a representative point for summaries based on unweighted triangulation.

FIG. 3B is a graph illustrating one example of identifying a representative point for summaries based on weighted triangulation.

FIG. 4A is a graph illustrating one example of identifying a collection of representative points for summaries based on unweighted remove-one robustness.

FIG. 4B is a graph illustrating one example of identifying a collection of representative points for summaries based on weighted remove-one robustness.

FIG. 5A is a graph illustrating one example of associating a topic with a document based on distance measures for the collection of representative points of FIG. 4A.

FIG. 5B is a graph illustrating one example of associating a topic with a document based on distance measures based on distance measures for the collection of representative points of FIG. 4B.

FIG. 6 is a block diagram illustrating one example of a computer readable medium for topic identification based on functional summarization.

FIG. 7 is a flow diagram illustrating one example of a method for topic identification based on functional summarization.

### DETAILED DESCRIPTION

Topic identification based on functional summarization is disclosed. A topic is a collection of terms and/or phrases that may represent a document or a collection of documents. Generally, a topic need not be derived from the document or the collection of documents. For example, a topic may be identified based on tags associated with the document or the collection of documents. Topic identification may be a bridge between extractive and semantic summarization, the bridge between keyword generations and document tagging, and/or the pre-populating of a document for use in search. As disclosed herein, multiple summarizers—as distinct summarizers or as combinations of two or more distinct summarizers using meta-algorithmic patterns—may be utilized for topic identification.

Topic identification-based tagging of documents may be performed in several different ways. In one instantiation, this may be performed via matching with search terms. In another, tagged documents may be utilized where, for example, subject headings may be utilized to define the topics. For example, MESH, or Medical Subject Headings, may be utilized.

As described in various examples herein, functional summarization is performed with combinations of summarization engines and/or meta-algorithmic patterns. A summarization engine is a computer-based application that receives a document and provides a summary of the document. The document may be non-textual, in which case appropriate techniques may be utilized to convert the non-textual document into a textual, or text-like behavior following, document prior to the application of functional summarization. A meta-algorithmic pattern is a computer-based application that can be applied to combine two or more summarizers, analysis algorithms, systems, and/or engines to yield meta-summaries. In one example, multiple meta-algorithmic patterns may be applied to combine multiple summarization engines.

Functional summarization may be applied for topic identification in a document. For example, a summary of a document may be compared to summaries available in a corpus of educational content to identify summaries that are most similar to the summary of the document, and topics associated with similar summaries may be associated with the document.

As described herein, meta-algorithmic patterns are themselves pattern-defined combinations of two or more summarization engines, analysis algorithms, systems, or engines; accordingly, they are generally robust to new samples and are able to fine tune topic identification to a large corpus of documents, addition/elimination/ingestion of new summarization engines, and user inputs. As described herein, meta-algorithmic approaches may be utilized to provide topic identification through a variety of methods, including (a) triangulation; (b) remove-one robustness; and (c) functional correlation,

As described in various examples herein, topic identification based on functional summarization is disclosed. One example is a system including a plurality of summarization engines, each summarization engine to receive, via a processing system, a document to provide a summary of the document. At least one meta-algorithmic pattern is applied to at least two summaries to provide a meta-summary of the document using the at least two summaries. A content processor identifies, from the meta-summaries, topics associated with the document, maps the identified topics to a collection of topic dimensions, and identifies a representative point based on the identified topics. An evaluator determines distance measures of the representative point from topic dimensions in the collection of topic dimensions, the distance measures indicative of proximity of respective topic dimensions to the representative point. A selector selects a topic dimension to be associated with the document, the selection based on optimizing the distance measures.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

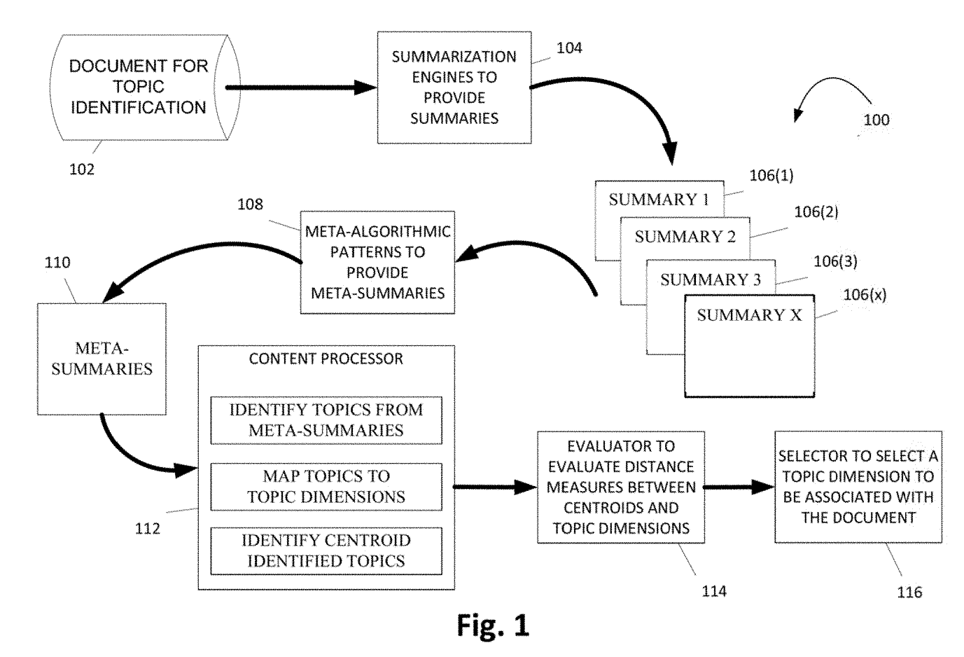

FIG. 1 is a functional block diagram illustrating one example of a system 100 for topic identification based on functional summarization. System 100 applies a plurality of summarization engines 104, each summarization engine to receive, via a processing system, a document 102 to provide a summary of the document. The summaries (e.g., Summary 1 106(1), Summary 2 106(2), Summary X 106(x)) may be further processed by at least one meta-algorithmic pattern 108 to be applied to at least two summaries to provide a meta-summary 110 of the document 102 using the at least two summaries.

Meta-summaries are summarizations created by the intelligent combination of two or more standard or primary summaries. The intelligent combination of multiple intelligent algorithms, systems, or engines is termed “meta-algorithmics”, and first-order, second-order, and third-order patterns for meta-algorithmics may be defined.

System 100 may receive a document 102 to provide a summary of the document 102. System 100 further includes a content processor 112, an evaluator 114, and a selector 116. The document 102 may include textual and/or non-textual content. Generally, the document 102 may include any material for which topic identification may need to be performed. In one example, the document 102 may include material related to a subject such as History Geography, Mathematics, Literature, Physics, Art, and so forth. In one example, a subject may further include a plurality of topics. For example, History may include a plurality of topics such as Ancient Civilizations, Medieval England, World War II, and so forth. Also, for example, Physics may include a plurality of topics such as Semiconductors, Nuclear Physics, Optics, and so forth. Generally, the plurality of topics may also be sub-topics of the topics listed,

Non-textual content may include an image, audio and/or video content. Video content may include one video, portions of a video, a plurality of videos, and so forth. In one example, the non-textual content may be converted to provide a plurality of tokens suitable for processing by summarization engines 104.

As described herein, individual topics may be arranged into topic dimensions. The topic dimension indicates a relative amount of content of a particular term (or related set of terms) in a given topic. The topic dimensions may be typically normalized.

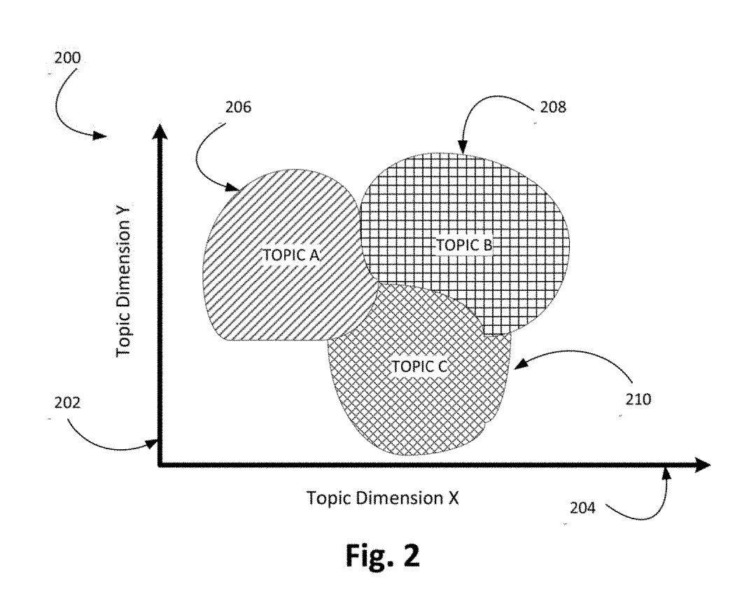

FIG. 2 is a schematic diagram illustrating one example of topics displayed in a topic dimension space 200. The topic dimension space 200 is shown to comprise two dimensions, Topic Dimension X 204 and Topic Dimension Y 202. In reality, however, the topic dimension space may include several dimensions, such as, for example, hundreds of dimensions. The axes of the topic dimension space may be typically normalized from 0.0 to 1.0. Examples of three topics arranged in the topic dimension space 200 are illustrated—Topic A 206, Topic B 208, and Topic C 210. In some examples, the topic dimension space 200 may be interactive and may be provided to a computing device via an interactive graphical user interface.

As illustrated in FIG. 2, Topic Dimension X 204 may represent relative occurrence of text on Australia, and Topic Dimension Y 202 may represent relative occurrence of text on mammals versus marsupials. Then, Topic A 206 may represent “opossum”, Topic B 208 may represent “platypus”, and Topic C 210 may represent “rabbit”.

Referring again to FIG. 1, in some examples, the summary (e.g., Summary 1 106(1), Summary 2 106(2), Summary X 106(x)) of the document 102 may be one of an extractive summary and an abstractive summary. Generally, an extractive summary is based on an extract of the document 102, and an abstractive summary is based on semantics of the document 102. In some examples, the summaries (e.g., Summary 1 106(1), Summary 2 106(2), . . . , Summary X 106(x)) may be a mix of extractive and abstractive summaries. A plurality of summarization engines 104 may be utilized to create the summaries (e.g., Summary 1 106(1), , Summary 2 106(2), . . . , Summary X 106(x)) of the document 102.

The summaries may include at least one of the following summarization outputs:
(1) a set of key words;
(2) a set of key phrases;
(3) a set of key images:
(4) a set of key audio;
(5) an extractive set of clauses;
(6) an extractive set of sentences;
(7) an extractive set of video clips
(8) an extractive set of clustered sentences, paragraphs, and other text chunks;
(9) an abstractive, or semantic, summarization.

In other examples, a summarization engine 104 may provide a summary (e.g., Summary 1 106(1), Summary 2 106(2), . . . , Summary X 106(x)) including another suitable summarization output. Different statistical language processing (“SLP”) and natural language processing (”NLP”) techniques may be used to generate the summaries. For example, a textual transcript of a video may be utilized to provide a summary.

In some examples, the at least one meta-algorithmic pattern 108 may be based on applying relative weights to the at least two summaries. In some examples, the relative weights may be determined based on one of proportionality to an inverse of a topic identification error, proportionality to accuracy squared, a normalized weighted combination of these, an inverse of a square root of the topic identification error, and a uniform weighting scheme.

In some examples, the weights may be proportional to the inverse of the topic identification error, and the weight for summarizer j may be determined as:

$${W}_{j} = \frac{1.0 ( 1.0 - {p}_{j} )}{{\sum }_{i = 1}^{{N}_{classifiers}} 1.0 / ( 1.0 - {p}_{i } )} \qquad ( Eqn . 1 )$$

As indicated in Eqn. 1, the weights derived from the inverse-error proportionality approach are already normalized—that is, sum to 1.0.

In some examples, the weights may be based on proportionality to accuracy squared. The associated weights may be determined as:

$${W}_{j} = \frac{{p}_{j}^{2}}{{\sum }_{i = 1}^{{N}_{classifiers}} {p}_{i}^{2}} \qquad ( Eqn . 2 )$$

In some examples, the weights may be a hybrid method based on a mean weighting of the methods in Eqn. 1 and Eqn. 2. For example, the associated weights may be determined as:

$${W}_{j} = {C}_{1} \frac{1.0 / ( 1.0 - {p}_{j} )}{{\sum }_{i = 1}^{{N}_{classifiers}} 1.0 / ( 1.0 - {p}_{i} )} + {C}_{2} \frac{{p}_{j}^{2}}{{\sum }_{i = 1}^{{N}_{classifiers}} {p}_{i}^{2}} \qquad ( Eqn . 3 )$$

where C₁+C₂=1.0. In some examples, these coefficients may be varied to allow a system designer to tune the output for different considerations-accuracy, robustness, the lack of false positives for a given class, and so forth.

In some examples, the weights may be based on an inverse of the square root of the error, for which the associated weights may be determined as:

$${W}_{j} = \frac{1.0 / \sqrt{1.0 - {p}_{j}}}{{\sum }_{i = 1}^{{N}_{classifiers}} 1.0 / \sqrt{1.0 - {p}_{i}}} \qquad ( Eqn . 4 )$$

System 100 includes a content processor 112 to identify, from the meta-summaries 110, topics associated with the document, map the identified topics to a collection of topic dimensions, and identify a representative point based on the identified topics. In some examples, the representative point may be a centroid of the regions representing the identified topics. In some examples, the representative point may be a weighted centroid of the regions representing the identified topics. Based on a weighting scheme utilized, summarization engines 104 may be weighted differently, resulting in a different representative point in combining the multiple summarizers.

System 100 includes an evaluator 114 to determine distance measures of the representative point from topic dimensions in the collection of topic dimensions, the distance measures indicative of proximity of respective topic dimensions to the representative point. In some examples, the distance measure may be a standard Euclidean distance. In some examples, the distance measures may be zero when the representative point overlaps with the given topic dimension.

System 100 includes a selector 116 to select a topic dimension to be associated with the document, the selection being based on optimizing the distance measures. In some examples, the selection is based on minimizing the distance measures. For example, the topic dimension that is at a minimum Euclidean distance from the representative point may be selected.

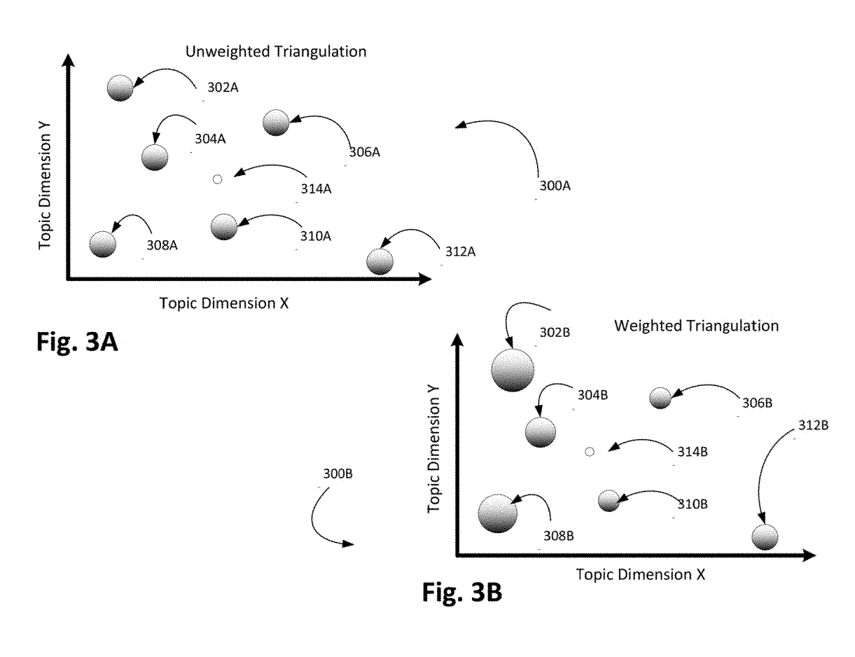

FIG. 3A is a graph illustrating one example of identifying a representative point for summaries based on unweighted triangulation. The topic dimension space 300A is shown to comprise two dimensions. Topic Dimension X along the horizontal axis, and Topic Dimension Y along the vertical axis. Summaries 302A, 304A, 306A, 308A, 310A, and 312A derived from six summarization engines are shown. In this example, all six summarization engines are weighted equally, i.e., uniform weights may be applied to all six summarization engines. This is indicated by all regions being represented by a circle of the same size. The representative point 314A is indicative of a centroid of the regions representing the six summaries. The representative point 314A may be compared to the topic map illustrated, for example, in FIG. 2. Based on such comparison, it may be determined that representative point 314A is proximate to Topic C 210 of FIG. 2. Accordingly, Topic C may be associated with the document. In some examples, the topic dimension space 300A may be interactive and may be provided to a computing device via an interactive graphical user interface.

FIG. 3B is a graph illustrating one example of identifying a representative point for summaries based on weighted triangulation. The topic dimension space 300B is shown to comprise two dimensions, Topic Dimension X along the horizontal axis, and Topic Dimension Y along the vertical axis. Summaries 302B, 304B, 306B, 308B, 310B, and 312B derived from six summarization engines are shown. In this example, all six summarization engines may not be weighted equally. This is indicated by regions being represented by circles of varying sizes, the size indicative of a relative weight applied to the respective summarization engine. The representative point 314B is indicative of a centroid of the regions representing the six summaries. As illustrated, based on applying relative weights, the representative point 314B of FIG. 3B is in a different position than the representative point 314A of FIG. 3A. The representative point 314B may be compared to the topic map illustrated, for example, in FIG. 2. Based on such a comparison, it may be determined that representative point 314B is proximate to Topic A 206 of FIG. 2. Accordingly, Topic A may be associated with the document. In some examples, the topic dimension space 300B may be interactive and may be provided to a computing device via an interactive graphical user interface.

In some examples, a remove-one robustness approach may be applied as a meta-algorithmic pattern. For example, a summarization engine of the plurality of summarization engines may be removed, and the representative point may be a collection of representative points, each identified based on summaries from summarization engines that are not removed. For example, if Summarization engines A, B, and C are utilized, then summary A may correspond to a summarization based on summarization engines B and C; summary B may correspond to a summarization based on summarization engines A and C; and summary C may correspond to a summarization based on summarization engines A and B. Accordingly, representative point A may correspond to summary A, representative point B may correspond to summary B, and representative point C may correspond to summary C.

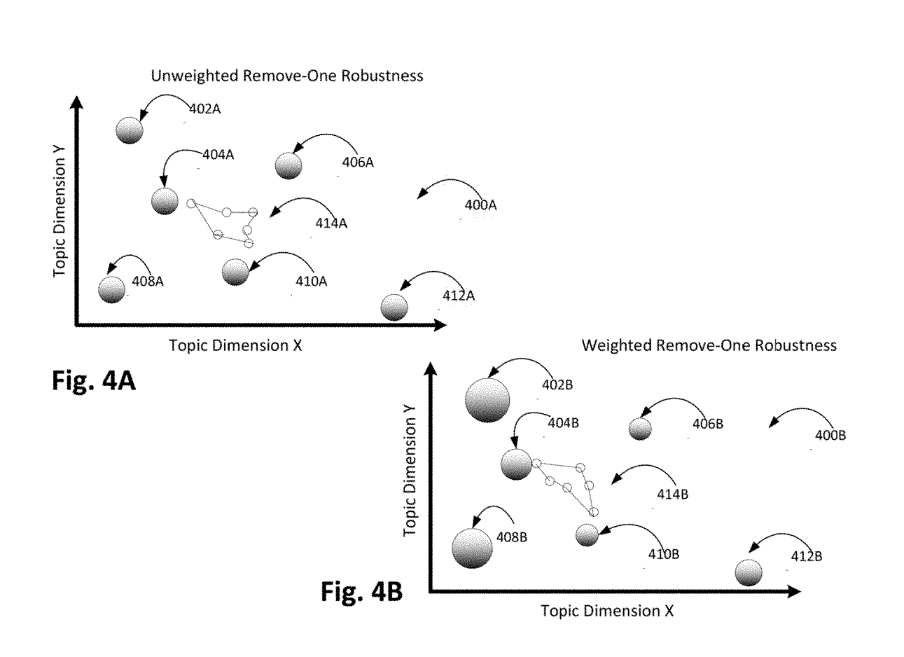

FIG. 4A is a graph illustrating one example of identifying a collection of representative points for summaries based on unweighted remove-one robustness. The topic dimension space 400A is shown to comprise two dimensions, Topic Dimension X along the horizontal axis, and Topic Dimension Y along the vertical axis. Summaries 402A, 404A, 406A, 408A, 410A, and 412A derived from six summarization engines are shown. In this example, all six summarization engines are weighted equally, i.e., uniform weights may be applied to all six summarization engines. This is indicated by all regions being represented by a circle of the same size. A single summarization engine is removed from consideration one at a time, and each time the representative point of the topics of the summarization texts not removed are plotted. Thus, six representative points 414A are computed based on removal of the six summarization engines. The six representative points 414A may be indicative of a centroid of the regions representing the six summaries.

FIG. 4B is a graph illustrating one example of identifying a collection of representative points for summaries based on weighted remove-one robustness. The topic dimension space 400B is shown to comprise two dimensions, Topic Dimension X along the horizontal axis, and Topic Dimension Y along the vertical axis. Summaries 402B, 404B, 406B, 408B, 410B, and 412B derived six summarization engines are shown. In this example, all six summarization engines may not be weighted equally. This is indicated by regions being represented by circles of varying sizes, the size indicative of a relative weight applied to the respective summarization engine. A single summarization engine is removed from consideration one at a time, and each time the representative point of the topics of the summarization texts not removed are plotted. Thus, six representative points 414B are computed based on removal of the six summarization engines. The six representative points 414B may be indicative of a centroid of the regions representing the six summaries.

In some examples, a distance measure of the collection of representative points to a given topic dimension may be determined as zero when a majority of representative points overlap with the given topic dimension. In some examples, a functional correlation scheme may be applied to identify the topic dimension. For example, a distance measure of the collection of representative points to a given topic dimension may be determined as zero when a majority of an area of a region determined by the collection of representative points overlaps with the given topic dimension. In some examples, the region determined by the collection of representative points may be a region determined by connecting the representative points, via for example, a closed arc. In some examples, the region determined by the collection of representative points may be a region determined by a convex hull of the representative points.

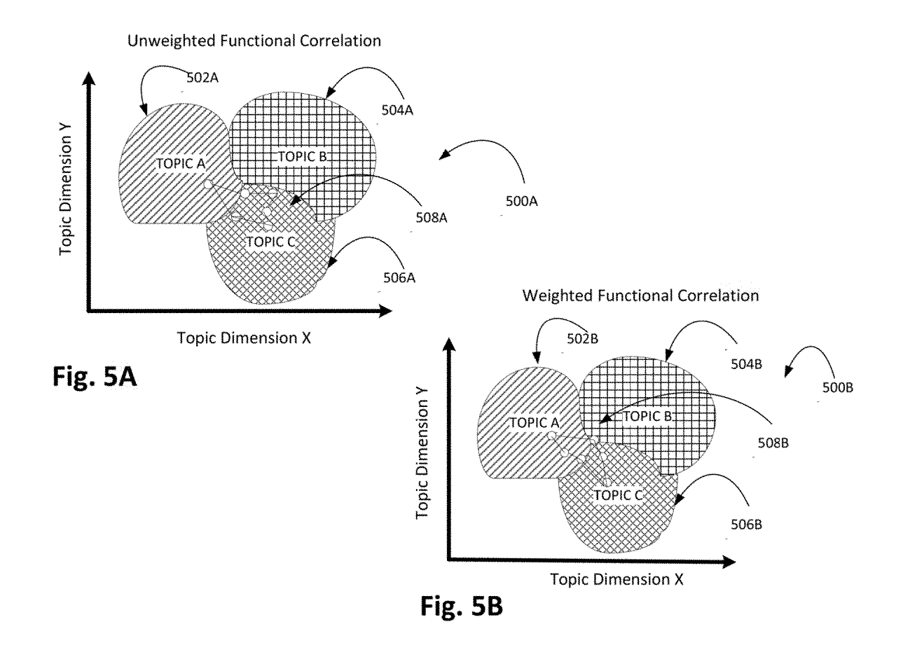

FIG. 5A is a graph illustrating one example of associating a topic with a document based on distance measures for the collection of representative points of FIG. 4A. The topic dimension space 500A is shown to comprise two dimensions, Topic Dimension X along the horizontal axis, and Topic Dimension Y along the vertical axis. Examples of three topics arranged in the topic dimension space 500A are illustrated—Topic A 502A, Topic B 504A, and Topic C 506A. For example, Topic Dimension X may represent relative occurrence of text on Australia, and Topic Dimension Y may represent relative occurrence of text on mammals versus marsupials. Then, Topic A 502A may represent “opossum”, Topic B 504A may represent “platypus”, and Topic C 506A may represent “rabbit”. In some examples, the topic dimension space 500A may be interactive and may be provided to a computing device via an interactive graphical user interface. Also shown are the six representative points 508A, determined, for example, based on the unweighted remove-one robustness method illustrated in FIG. 4A.

A distance measure of the six representative points 508A to a given topic dimension may be determined as zero when a majority of representative points 508A overlap with the given topic dimension. For example, the representative points 508A may be compared to the topic map in the topic dimension space 500A. Based on such a comparison, it may be determined that a majority of representative points 508A are proximate to Topic C 508A since five of the representative points 508A overlap with Topic C 506A, and one overlaps with Topic A 502A. Accordingly, Topic C, representing “rabbit”, may be associated with the document. In some examples, the topic dimension space 500A may be interactive and may be provided to a computing device via an interactive graphical user interface.

In some examples, a distance measure of the six representative points 508A to a given topic dimension may be determined as zero when a majority of an area of a region determined by the representative points 508A overlaps with the given topic dimension. In the example illustrated herein, the region is determined by connecting the points in the representative points 508A. As illustrated, it may be determined that a majority of the area based on the representative points 508A overlaps with the region represented by Topic C 508A. Accordingly, Topic C, representing “rabbit”, may be associated with the document.

FIG. 5B is a graph illustrating one example of associating a topic with a document based on distance measures based on distance measures for the collection of representative points of FIG. 4B. The topic dimension space 500B is shown to comprise two dimensions, Topic Dimension X along the horizontal axis, and Topic Dimension Y along the vertical axis. Examples of three topics arranged in the topic dimension space 500B are illustrated—Topic A 502B, Topic B 504B, and Topic C 506B. For example, Topic Dimension X may represent relative occurrence of text on Australia, and Topic Dimension Y may represent relative occurrence of text on mammals versus marsupials. Then, Topic A 502B may represent “opossum”, Topic B 504B may represent “platypus”, and Topic C 506B may represent “rabbit”. In some examples, the topic dimension space 500B may be interactive and may be provided to a computing device via an interactive graphical user interface. Also shown are the six representative points 508B, determined, for example, based on the weighted remove-one robustness method illustrated in FIG. 4B.

A distance measure of the six, representative points 508B to a given topic dimension may be determined as zero when a majority of representative points 508B overlap with the given topic dimension. For example, the representative points 508B may be compared to the topic map in the topic dimension space 500B. Based on such a comparison, it may be determined that a majority of representative points 508B are proximate to Topic A 502B since three of the representative points 508B overlap with Topic A 502B, two overlap with Topic C 506B, and one overlaps with Topic B 504B. Accordingly, Topic A, representing “opossum”, may be associated with the document. In some examples, the topic dimension space 500B may be interactive and may be provided to a computing device via an interactive graphical user interface.

In some examples, a distance measure of the six representative points 508B to a given topic dimension may be determined as zero when a majority of an area of a region determined by the representative points 508B overlaps with the given topic dimension. In the example illustrated herein, the region is determined by connecting the points in the representative points 508B. As illustrated, it may be determined that a majority of the area based on the representative points 508B overlaps with the region represented by Topic A 502B. Accordingly, Topic A, representing “opossum”, may be associated with the document.

Referring again to FIG. 1, in some examples, system 100 may include a display module (not illustrated in FIG. 1) to provide a graphical display, via an interactive graphical user interface, of the representative point and the topic dimensions, wherein each orthogonal axis of the graphical display represents a topic dimension. In some examples, the selector 116 may further select the topic dimension by receiving input via the interactive graphical user interface. For example, a user may select a topic from a topic map and associate the document 102 with the selected topic. In some examples, an additional summarization engine may be automatically added based on input received via the interactive graphical user interface. For example, based on a combination of summarization engines and meta-algorithmic patterns, a user may select a topic, associated with the document 102, that was not previously represented in a collection of topics, and the combination of summarization engines and meta-algorithmic patterns that generated the summary and/or meta-summary may be automatically added for deployment by system 100.

The components of system 100 may be computing resources, each including a suitable combination of a physical computing device, a virtual computing device, a network, software, a cloud infrastructure, a hybrid cloud infrastructure that may include a first cloud infrastructure and a second cloud infrastructure that is different from the first cloud infrastructure, and so forth. The components of system 100 may be a combination of hardware and programming for performing a designated visualization function. In some instances, each component may include a processor and a memory, while programming code is stored on that memory and executable by a processor to perform a designated visualization function.

For example, each summarization engine 104 may be a combination of hardware and programming for generating a designated summary. For example, a first summarization engine may include programming to generate an extractive summary, say Summary 1 106(1), whereas a second summarization engine may include programming to generate an abstractive summary, say Summary X 106(x). Each summarization engine 104 may include hardware to physically store the summaries, and processors to physically process the document 102 and determine the summaries. Also, for example, each summarization engine may include software programming to dynamically interact with the other components of system 100.

Likewise, the content processor 112 may be a combination of hardware and programming for performing a designated function. For example, content processor 112 may include programming to identify, from the meta-summaries 110, topics associated with the document 102. Also, for example, content processor 112 may include programming to map the identified topics to a collection of topic dimensions, and to identify a representative point based on the identified topics. Content processor 112 may include hardware to physically store the identified topics and the representative point, and processors to physically process such objects. Likewise, evaluator 114 may include programming to evaluate distance measures, and selector 116 may include programming to select a topic dimension.

Generally, the components of system 100 may include programming and/or physical networks to be communicatively linked to other components of system 100. In some instances, the components of system 100 may include a processor and a memory, while programming code is stored and on that memory and executable by a processor to perform designated functions.

Generally, interactive graphical user interfaces may be provided via computing devices. A computing device, as used herein, may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to perform, a unified visualization interface. The computing device may include a processor and a computer-readable storage medium.

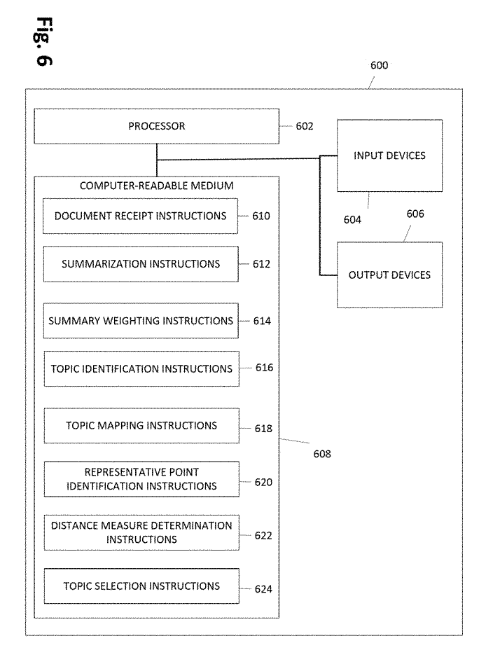

FIG. 6 is a block diagram illustrating one example of a computer readable medium for topic identification based on functional summarization. Processing system 600 includes a processor 602, a computer readable medium 608, input devices 604, and output devices 606. Processor 602, computer readable medium 608, input devices 604, and output devices 606 are coupled to each other through a communication link (e.g., a bus).

Processor 602 executes instructions included in the computer readable medium 608. Computer readable medium 608 includes document receipt instructions 610 to receive, via a computing device, a document to be associated with a topic.

Computer readable medium 608 includes summarization instructions 612 to apply a plurality of summarization engines to the document to provide a summary of the document.

Computer readable medium 608 includes summary weighting instructions 614 to apply relative weights to at least two summaries to provide a meta-summary of the document using the at least two summaries, where the relative weights are determined based on one of proportionality to an inverse of a topic identification error, proportionality to accuracy squared, a normalized weighted combination of these, an inverse of a square root of the topic identification error, and a uniform weighting scheme.

Computer readable medium 608 includes topic identification instructions 616 to identify, from the meta-summaries, topics associated with the document.

Computer readable medium 608 includes topic mapping instructions 618 to map the identified topics to the topic dimensions in a collection of topic dimensions retrieved from a repository of topic dimensions.

Computer readable medium 608 includes representative point identification instructions 620 to identify a representative point of the identified topics.

Computer readable medium 608 includes distance measure determination instructions 622 to determine distance measures of the representative point from topic dimensions in the collection of topic dimensions, the distance measures indicative of proximity of respective topic dimensions to the representative point.

Computer readable medium 608 includes topic selection instructions 624 to select a topic dimension to be associated with the document, the selection based on optimizing the distance measures.

Input devices 604 include a keyboard, mouse, data ports, and/or other suitable devices for inputting information into processing system 600. In some examples, input devices 604, such as a computing device, are used by the interaction processor to receive a document for topic identification. Output devices 606 include a monitor, speakers, data ports, and/or other suitable devices for outputting information from processing system 600. In some examples, output devices 606 are used to provide topic maps.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 608 can include one of or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks: other magnetic media including tape; optical media such, as compact disks (CDs) or digital video disks (DVDs); or other types of storage devices.

As described herein, various components of the processing system 600 are identified and refer to a combination of hardware and programming configured to perform a designated visualization function. As illustrated in FIG. 6, the programming may be processor executable instructions stored on tangible computer readable medium 608, and the hardware may include processor 602 for executing those instructions. Thus, computer readable medium 608 may store program instructions that, when executed by processor 602, implement the various components of the processing system 600.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 608 may be any of a number of memory components capable of storing instructions that can be executed by Processor 602. Computer readable medium 608 may be non-transitory in the sense that it does not encompass a transitory signal but instead is made up of one or more memory components configured to store the relevant instructions. Computer readable medium 608 may be implemented in a single device or distributed across devices. Likewise, processor 602 represents any number of processors capable of executing instructions stored by computer readable medium 608. Processor 602 may be integrated in a single device or distributed across devices. Further, computer readable medium 608 may be fully or partially integrated in the same device as processor 602 (as illustrated), or it may be separate but accessible to that device and processor 602. In some examples, computer readable medium 608 may be a machine-readable storage medium.

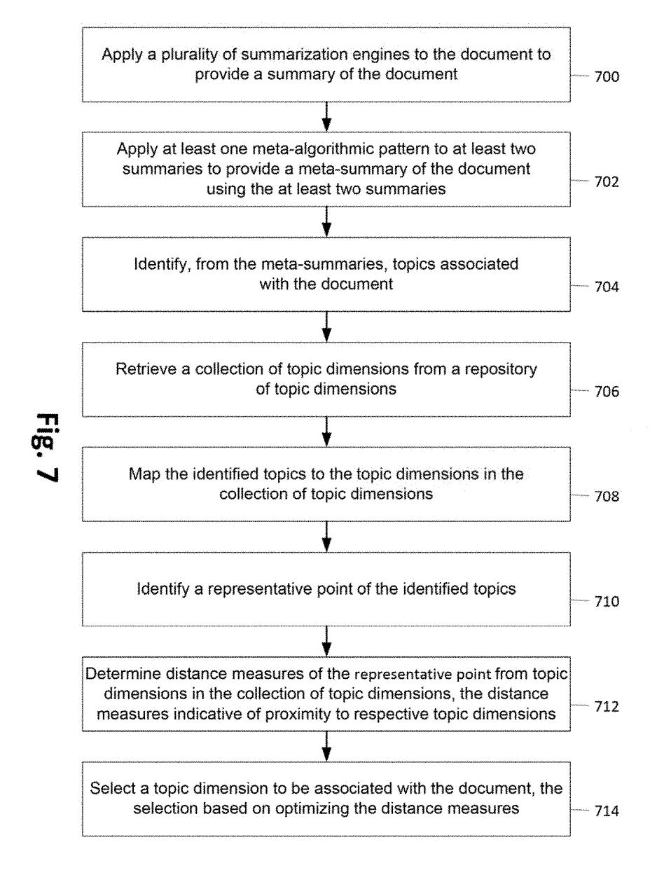

FIG. 7 is a flow diagram illustrating one example of a method for topic identification based on functional summarization.

At 700, a plurality of summarization engines, may be applied to the document to provide a summary of the document.

At 702, at least one meta-algorithmic pattern may be applied to at least two summaries to provide a meta-summary of the document using the at least two summaries.

At 704, topics associated with the document may be identified from the meta-summaries.

At 706, a collection of topic dimensions may be retrieved from a repository of topic dimensions.

At 708, the identified topics may be mapped to the topic dimensions in the collection of topic dimensions.

At 710, a representative point may be identified based on the identified topics.

At 712, distance measures of the representative point from topic dimensions in the collection of topic dimensions may be determined, the distance measures indicative of proximity of respective topic dimensions to the representative point.

At 714, a topic dimension to be associated with the document may be selected, the selection based on optimizing the distance measures.

In some examples, the at least one meta-algorithmic pattern is based on applying relative weights to the at least two summaries.

In some examples, the method further includes adding, removing and/or automatically ingesting a summarization engine of the plurality of summarization engines, and wherein the representative point is a collection of representative points, each identified based on summaries from summarization engines that are not removed.

In some examples, the method further includes providing a graphical display, via an interactive graphical user interface, of the representative point and the topic dimensions, wherein each orthogonal axis of the graphical display represents a topic dimension.

Examples of the disclosure provide a generalized system for topic identification based on functional summarization. The generalized system provides a pattern-based, automatable approaches that are very readily deployed with a plurality of summarization engines. Relative performance of the summarization engines on a given set of documents may be dependent on a number of factors, including the number of topics, the number of documents per topic, the coherency of the document set, the amount of specialization with the document set, and so forth. The approaches described herein provide greater flexibility than a single approach, and utilizing the summaries rather than the original documents allows better identification of key words and phrases within the documents, which may generally be more conducive to accurate topic identification.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a plurality of summarization engines, each summarization engine to receive, via a processing system, a document to provide a summary of the document;
at least one meta-algorithmic pattern to be applied to at leas two summaries to provide a meta-summary of the document using the at least two summaries;
a content processor to:
identify, from the meta-summaries, topics associated with the document,
map the identified topics to a collection of topic dimensions, and
identify a representative point based on the identified topics;
an evaluator to determine distance measures of the representative point from topic dimensions in the collection of topic dimensions, the distance measures indicative of proximity of respective topic dimensions to the representative point; and
a selector to select a topic dimension to be associated with the document, the selection based on optimizing the distance measures.

2. The system of claim 1, wherein the at least one meta-algorithmic pattern is based on applying relative weights to the at least two summaries.

3. The system of claim 2, wherein the relative weights are determined based on one of proportionality to an inverse of a topic identification error, proportionality to accuracy squared, a normalized weighted combination of these, an inverse of a square root of the topic identification error, and a uniform weighting scheme.

4. The system of claim 1, further comprising removing a summarization engine of the plurality of summarization engines, and wherein the representative point is a collection of representative points, each identified based on summaries from summarization engines that are not removed.

5. The system of claim 4, wherein a distance measure of the collection of representative points to a given topic dimension is zero when a majority of representative points overlap with the given topic dimension.

6. The system of claim 4, wherein a distance measure of the collection of representative points to a given topic dimension is zero when a majority of an area of a region determined by the collection of representative points overlaps with the given topic dimension.

7. The system of claim 1, further comprising a display module to provide a graphical display, via an interactive graphical user interface, of the representative point and the topic dimensions, wherein each orthogonal axis of the graphical display represents a topic dimension.

8. The system of claim 7, wherein the selector to further select the topic dimension by receiving input via the interactive graphical, user interface.

9. The system of claim 7, further comprising an automatic addition of an additional summarization engine based on input received via the interactive graphical user interface.

10. The system of claim 1, wherein the summary of the document is one of an extractive summary and an abstractive summary.

11. A method to identify a topic for a document, the method comprising:
applying a plurality of summarization engines to the document to provide a summary of the document;
applying at least one meta-algorithmic pattern to at least two summaries to provide a meta-summary of the document using the at least two summaries;
identifying, from the meta-summaries, topics associated with the document;
retrieving a collection of topic dimensions from a repositor of topic dimensions;
mapping the identified topics to the topic dimensions in the collection of topic dimensions;
identifying a representative point based on the identified topics;
determining distance measures of the representative point from topic dimensions in the collection of topic dimensions, the distance measures indicative of proximity of respective topic dimensions to the representative point; and
selecting a topic dimension to be associated with the document, the selection based on optimizing the distance measures.

12. The method of claim 11, wherein the at least one meta-algorithmic pattern is based on applying relative weights to the at least two summaries.

13. The method of claim 11, further comprising removing a summarization engine of the plurality of summarization engines, and wherein the representative point is a collection of representative points, each identified based on summaries from summarization engines that are not removed.

14. The method of claim 11, further comprising providing a graphical display, via an interactive graphical user interface, of the representative point and the topic dimensions, wherein each orthogonal axis of the graphical display represents a topic dimension.

15. A non-transitory computer readable medium comprising executable instructions to:
receive, via a computing device, a document to be associated with a topic;
apply a plurality of summarization engines to the document to provide a summary of the document;
apply relative weights to at least two summaries to provide a meta-summary of the document using the at least two summaries, wherein the relative weights are determined based on one of proportionality to an inverse of a topic identification error, proportionality to accuracy squared, a normalized weighted combination of these, an inverse of a square root of the topic identification error, and a uniform weighting scheme;
identify, from the meta-summaries, topics associated with the document;
map the identified topics to the topic dimensions in a collection of topic dimensions retrieved from a repository, of topic dimensions;
identify a representative point of the identified topics;
determine distance measures of the representative point from topic dimensions in the collection of topic dimensions, the distance measures indicative of proximity of respective topic dimensions to the representative point; and
select a topic dimension to be associated with the document, the election based on optimizing the distance measures.
